(19) United States
(12) Patent Application Publication
(10) Pub. No.: US 2003/0143015 A1
(43) Pub. Date: Jul. 31, 2003

(54) Lipstick tube structure

(76) Inventor: Gabriel Bouzaglo, Bellignat (FR)

Correspondence Address: CANTOR COLBURN, LLP, 55 GRIFFIN ROAD SOUTH, BLOOMFIELD, CT, 06002

(21) Appl. No.: 10/221,078

(22) PCT Filed: Mar. 8, 2001
(86) PCT No.: PCT/FR01/00703

(30) Foreign Application Priority Data
Mar. 9, 2000 (FR) 00/03053

(51) Int. Cl. B43K 21/08

(52) U.S. Cl. 401/68

(57) ABSTRACT

The invention concerns a structure (1) comprising a base (2), a body (3), a slider (4), respective means (9, 13) for the pivoted assembling of the base (2) and the body (3), respective means (8, 21) for locking the slider (4) in rotation, and respective means (24, 25) of the pin-helical groove type for moving the slider (4). The invention is characterised in that the respective means (8, 21) locking the slider (4) in rotation are arranged in radially internal zones of the base (2) and of the slider (4); the body (3) comprises at least a pin (14) projecting radially inwards, from its wall (10) which defines said axial conduit (11), and the slider (4) comprises at last a helical groove (25) arranged in its wall (15), standing from its outer surface, each pin (14) of the body (3) being arranged such that it is positioned at the entrance of each helical groove (25) of the slider (4) when said respective means (9, 13) assembling the base (2) and the body (3) are engaged with each other.

The present invention relates to a lipstick tube structure.

In the case of certain lipstick tubes, it is desirable to obtain a minimal cost price, which requires the simplest possible lipstick tube structure and parts that are easy to manufacture and to assemble.

A known lipstick tube structure comprises only four parts molded from synthetic material, namely a base, a body, a slide, and a cap. The base delimits an axial cavity for receiving the slide, and has one or two studs projecting radially into this cavity; this base also comprises a collar close to its end for receiving the body.

The latter delimits an axial conduit for allowing the displacement of the slide, and has one or two axial grooves opening out in this conduit; this body also comprises a channel allowing its snap-fitting over said collar of the base, with the possibility of pivoting, in order to allow the assembly of the base and of the body and the pivoting of this base relative to this body.

The slide comprises a cavity opening out in one of its axial ends, in which the stick of lipstick may be fitted; this slide also has one or two helical grooves capable of interacting with said stud or studs in the base; it also comprises, close to its end receiving the stick of lipstick, one or two studs capable of sliding in said grooves in the body, in order to block the slide in rotation relative to this body.

The cap comprises a cavity for its engagement over the body, and means for holding it on the latter.

A lipstick tube of this type admittedly has a structure that is relatively simple to manufacture, but its drawback is that it is relatively difficult to assemble, particularly in terms of the positioning of the slide in the base, which involves either entraining the slide in rotation so as to engage and then to slide the studs in the base in the helical grooves in the slide, which is relatively difficult to achieve, or to forcibly axially engage the slide over these studs, at the risk of damaging these studs and of obtaining a lipstick tube with defective operation.

The present invention aims to remedy these drawbacks. Its object is to provide a lipstick tube structure that is both simple and easy to manufacture, and that comprises parts that are easy to assemble.

In a manner known per se, this structure comprises a base, a body, a slide and an optional cap; the base and the body, respectively, delimit an axial cavity and an axial conduit for the reception and the displacement of the slide; the slide comprises a cavity opening out in one of its axial ends, in which the stick of lipstick may be fitted; this structure also comprises respective means for assembling the base and the body with the possibility of pivoting of this base relative to this body, respective means for blocking the slide in rotation, and respective means of the stud/helical groove type for displacement of the slide relative to the base and the body after pivoting of the base relative to the body.

### ACCORDING TO THE INVENTION

said respective means for blocking the slide in rotation are arranged in radially inside zones of the base and of the slide;

the body comprises at least one stud projecting radially inward from its wall that delimits said axial conduit, and

the slide comprises at least one helical groove arranged in its wall starting from its outer face;

each stud of the body being arranged such that it is at the entry to each helical groove of the slide when said respective means for assembling the base and the body are in engagement.

This structure comprises parts that are simple to manufacture and use little material. In particular, the arrangement of said blocking means in the radially inside zone of the slide and of the base makes it possible to arrange the helical groove or grooves in the outer face of the slide, which makes it possible to obtain a slide that is easy to remove from its mold. The same applies to the body, which has a simple structure.

Said structure is also easy to assemble since assembly comprises the simple engagement of the slide in the base by means of sliding, and then simple snap-fitting of the body over the base.

It is possible for the entry to each helical groove in the slide not to open out in the end of the slide facing the body, in which case, each stud is forcibly engaged over the slide. Deformation of the material forming the body and the slide and the short length of the zone to be crossed, prevent, or at the very least very greatly reduce, the risk of damage to the stud or studs. The entry to each groove may also open out in the end of the slide facing the body in order to eliminate any forcible engagement of the body over the slide.

Said respective blocking means may simply consist of a tongue with prismatic cross section, for example a rectangular cross section, integral with the base, and of a slot, having a corresponding cross section, arranged in the slide.

The invention will be properly understood with the aid of the attached diagrammatic drawing that represents, by way of non-limiting example, a possible embodiment of the lipstick tube structure to which it relates.

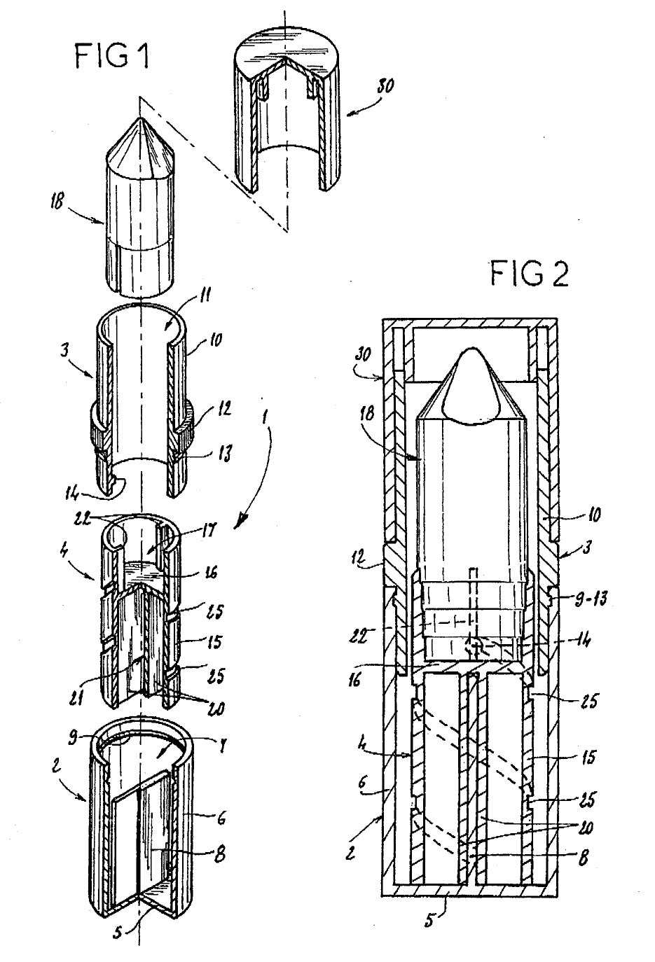

FIG. 1 is a perspective, sectional view of a base, a body, a slide, and a cap that it comprises, and,

FIG. 2 is a side view in axial section of these same parts, after assembly.

The figures show a lipstick tube structure 1 comprising a base 2, a body 3, and a slide 4.

The structure 1 also comprises a cap 30 configured in order to be slipped over the body 3.

These various parts are molded from a synthetic material.

The base 2 has a bottom 5 and a peripheral wall 6, which delimit an axial cavity 7 for receiving the slide 4.

The base 2 also comprises a tongue 8 with a rectangular cross section, integral with the bottom 5 and arranged diametrically.

This base 2 also comprises a channel 9 arranged in its side opposite the bottom 5, starting from the inner face of the wall 6.

The body 3 has a peripheral wall 10 that gives it a tubular structure such that it delimits an axial conduit 11 for allowing the displacement of the slide 4 in it.

This body 3 also comprises a collar 12, a keeper ring 13, and two studs 14.

The collar 12 projects from the wall 10 and delimits a lower shoulder capable of bearing against the base 2.

The keeper ring 13 is capable of being snap-fitted into the channel 9 and of sliding in it. This keeper ring 13 and this channel 9 thus allow the assembly of the base 2 and body 3, with the possibility of pivoting of this base 2 relative to this body 3 in order to allow the displacement of the slide 4 through the body 3.

The studs 14 are diametrically opposed and project from the wall 10 radially inward. These studs 14 are arranged close to the end of the body 3 that is intended for engagement in the base 2.

The slide 4 comprises a peripheral wall 15, which gives it a general tubular structure. It has a transverse web 16, which delimits, on one side, a cavity 17 capable of receiving the stick 18 of lipstick and which includes, on its side opposite this cavity 17, two parallel walls 20. These walls 20 together delimit a slot 21 with a shape that corresponds to that of the tongue 8. This slot 21 has a size such that the tongue 8 can be engaged and can slide in it, while allowing blocking of the slide 4 in rotation relative to the base 2.

The slide 4 also comprises two walls 22 projecting from the wall 10 radially and toward the inside of the cavity 17. These walls 22 form means for blocking and holding the stick 18 in this cavity 17.

In addition, the slide 4 comprises two helical grooves 25, arranged in its wall 15 starting from the outer face of said wall. These grooves 25 are offset by a half pitch relative to one another, and are of such a size as to receive the studs 14 with sliding.

As shown, the slide 4 is intended for engagement in the base 2 until it comes to rest against the bottom 5, the tongue 8 being received in the slot 21. The body 3 is then engaged over the base 2 until the keeper ring 13 snap-fits into the channel 9. In this snap-fitting position, the collar 12 comes to rest against the upper edge of the base 2, and each stud 14 is located at the entry to the corresponding groove 25.

Pivoting of the base 2 relative to the body 3 then allows the slide 4, and thus the stick 18, to be displaced through the body 3.

As is apparent from the above, the invention provides a lipstick tube structure having, compared to similar structures of the prior art, the advantages of being both simple and easy to manufacture, and of comprising parts that are easy to assemble.

It goes without saying that the invention is not limited to the embodiment described above by way of example, but that, on the contrary, it encompasses all variant embodiments. Thus, the tongue could be replaced by a square-section rod.

1. A lipstick tube structure comprising a base (2), a body (3), a slide (4) and an optional cap (30); the base (2) and the body (3), respectively, delimit an axial cavity (7) and an axial conduit (11) for the reception and the displacement of the slide (4); the slide (4) comprises a cavity (17) opening out in one of its axial ends, in which the stick (18) of lipstick may be fitted; this structure (1) also comprises respective means (9, 13) for assembling the base (2) and the body (3) with the possibility of pivoting of this base (2) relative to this body (3), respective means (8, 21) for blocking the slide (4) in rotation, and respective means (14, 25) of the stud/helical groove type for displacement of the slide (4) relative to the base (2) and the body (3) after pivoting of the base (2) relative to the body (3);
structure (1) characterized in that;
said respective means (8, 21) for blocking the slide (4) in rotation are arranged in radially inside zones of the base (2) and of the slide (4);
the body (3) comprises at least one stud (14) projecting radially inward from its wall (10) that delimits said axial conduit (11), and
the slide (4). comprises at least one helical groove (25) arranged in its wall (15) starting from its outer face;
each stud (14) of the body (3) being arranged such that it is at the entry to each helical groove (25) of the slide (4) when said respective means (9, 13) for assembling the base (2) and the body (3) are in engagement.

2. The structure as claimed in claim 1, characterized in that the entry to each helical groove of the slide (4) opens out in the end of the slide (4) facing the body (3).

3. The structure as claimed in claim 1 or claim 2, characterized in that said respective blocking means (8, 21) consist of a tongue (8) of prismatic cross section, for example of rectangular cross section, integral with the base (2), and of a slot (21) having a corresponding cross section, arranged in the slide (4).
